(19) United States
(12) Patent Application Publication
(10) Pub. No.: US 2007/0175674 A1
(43) Pub. Date: Aug. 2, 2007

(54) SYSTEMS AND METHODS FOR RANKING TERMS FOUND IN A DATA PRODUCT

(75) Inventors: Robert M. Brinson JR., Rome, GA (US); Bryan Glenn Donaldson, Cumming, GA (US); Nicholas Levi Middleton, Cartersville, GA (US); Robert Leon Bass, Decatur, GA (US); Harry H. Blakeslee, Dunwoody, GA (US)

Correspondence Address: BLACK LOWE & GRAHAM, PLLC, 701 FIFTH AVENUE, SUITE 4800, SEATTLE, WA, 98104, US

(73) Assignee: Intelliscience Corporation, Atlanta, GA (US)

(21) Appl. No.: 11/733,478

(22) Filed: Apr. 10, 2007

Related U.S. Application Data
(63) Continuation-in-part of application No. 11/336,743, filed on Jan. 19, 2006.
(60) Provisional application No. 60/744,570, filed on Apr. 10, 2006.

(51) Int. Cl. G01G 19/08

(52) U.S. Cl. 177/136

(57) ABSTRACT

A method for determining the significance of a term in a plurality of data products. The data products are stored on a single computer, at one or more locations over a computer-based network, or on the world wide web. The method determines the type of the data product. The data product is assigned a weight value based on a list of predetermined variables. A processor calculates a weight value for each term inside the data product. The weight value equals the weight value assigned to the data product added to the weight value of the term calculated based on a list of predetermined variables. The list of terms and calculated weight values are stored for each term.

### PRIORITY CLAIM

This application claims priority to provisional patent application Ser. No. 60/744,570, filed on Apr. 10, 2006 and is herein incorporated by reference in its entirety. This application is continuation-in-part of utility application Ser. No. 11/336,743, filed on Jan. 19, 2006 and is herein incorporated by reference in its entirety.

### BACKGROUND OF THE INVENTION

Conventional search engines use methods of ranking based primarily on pre-classified, clustered, or tagging solutions. Each of these solutions is centered on a “developer” driven search methodology.

Classification solutions use classifications for the words that a developer puts in place prior-to searching. For example “bass” would fit in the classifications of: type of fish, style of guitar, type of stringed instrument, an Artist, brand of shoes, and brand of alcoholic beverage. Currently, classification does not support “concept” searching; classification relies on the appropriateness of the classification to be relevant to each and every searcher's word. It is improbable that any classification system will ever be able to reach a saturation point of classifying all words for all searchers.

Conventional clustering solutions formulate algorithms to present results based on clusters of other users' past searches of the current searcher's current search word. Searchers of the word “bass” will be presented ranked results based on the frequency of the “hit” sites from other searchers. Clustering does not support “concept” searching. Clustering relies on the appropriateness of the large groupings of other searchers for the same words. Research shows that between 55% and 75% of Internet searches do not result in success, thus, clustering results can be based on “hit” sites from failed searches. Clustered search results will always miss the target for an unknown number of searchers who are looking for other results than those presented.

Tagging solutions are in essence another variation of the classification system. Rather than the engineer, it lets web page developers/owners classify their pages with the use of keywords and meta-tags. A sporting goods store, and the manufacturer of certain ale's, shoes and guitars, might all place the word “bass” in their keywords or meta-tags. Tagging does not support “concept” searching. Tagging solutions rely on the appropriateness, integrity & domain knowledge of web page developers/owners. It has become rather common on the web for pages to have keywords and meta-tags that have nothing to do with the content or purpose of the site. In these cases, these tags have been placed solely to drive traffic to the site. Tagging solutions are one of the contributing factors to the high number of search sessions that fail to deliver the desired page or file.

These conventional search ranking methodologies have been successful at bringing users into the electronic search world, however they can be considered rather static as they are not very interactive for the searcher and will typically return the same results. While these ranking methods have provided some narrowing of the web search area, they provide little assistance in narrowing searches of the computer desktop or network which is primarily due to the fact that it is developer driven and as each computer user's personal computer and network contents are unique, there are no developers to put in place a classification, clustering or tagging solution.

Current ranking methodologies result is only moderately successful search sessions. Further, the absence of a working ranking solution for the desktop and network exposes the need for a dramatic shift in ranking beyond methodologies to a shift in the ranking paradigm.

### SUMMARY OF THE INVENTION

The preferred embodiment provides methods and systems for determining the significance of a term in a plurality of data products. The data products are stored on a single computer, at one or more locations over a computer-based network, or on the world wide web. An example method determines the type of the data product. The data product is assigned a weight value based on a list of predetermined variables and variables dynamically created through the search, processing and concept association processes. A processor calculates a weight value for each term inside the data product. The weight value equals the weight value assigned to the data product added to the weight value of the term calculated based on a list of predetermined variables. The list of terms and calculated weight values are stored for each term.

### BRIEF DESCRIPTION OF THE DRAWINGS

The preferred and alternative embodiments of the present invention are described in detail below with reference to the following drawings.

FIG. 1 shows an example system for ranking terms found in a data product;

FIG. 2 shows an example formed in accordance with an embodiment of the present invention;

FIG. 3 shows an example for assigning a weight value to a term;

FIG. 4 shows an example for determining a weight value of a data product type;

FIG. 5 shows an example method for determining a weight value of a term in a data product containing text;

FIG. 6 shows an example of including user specifications;

FIG. 7 shows one embodiment of scanning data products and storing weight values;

FIG. 8 shows an example table that stores terms, weight values, and the data product location; and

FIG. 9 shows an example of how a list of weighted terms is used by a search query.

### DETAILED DESCRIPTION OF THE PREFERRED EMBODIMENT

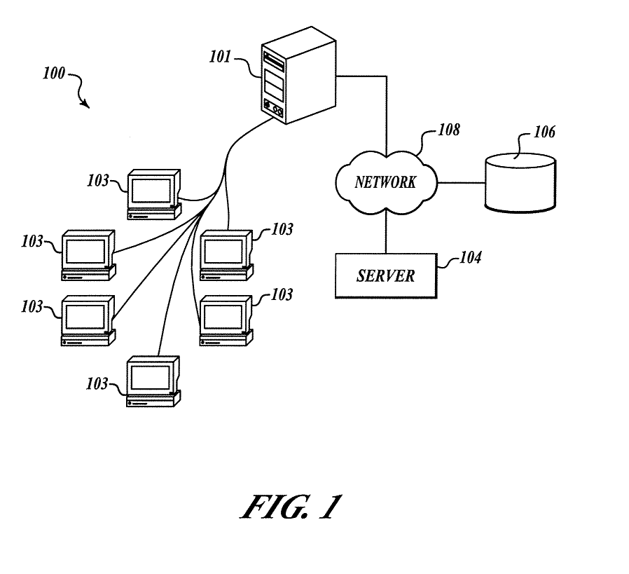

FIG. 1 shows an example system 100 for ranking terms found in a data product. In one embodiment, the system 100 includes a computer 101 in communication with a plurality of other computers 103. In an alternate embodiment, the computer 101 is connected with a plurality of computers 103, a server 104, a data storage center 106, and/or a network 108, such as an intranet or the Internet. Also a bank of servers, a wireless device, a cellular phone and/or another data entry device can be used in the place of the computer 101. In one embodiment, a database stores terms and a plurality of weight values. The database is stored at the data storage center 106 or locally at the computer 101.

In one embodiment, an application program run by the server 104 or computer 101 creates initial database tables. The tables store terms found in each of a plurality of the data products, their respective weight values, as well as the relationships between each table, and data product locations. A term includes a word, a phrase and/or a concept. A term's weight value is defined as a number assigned to a word, such that in a computation the word's effect on the computation reflects its importance. The application program monitors the data products for changes and updates the database tables when a change has occurred or a new data product has been made available.

In one embodiment, calculating a weight value of terms found in a data product is executed on a single computer 101. In one embodiment, a search for a data product is executed on a computer 101 connected to a plurality of computers 103, a server 104, a data storage center 106, and/or a network 108, such as an intranet or the Internet. Search over the Internet allows a user to search and rank a plurality of Internet pages.

In one embodiment, the data products could be of any format containing text, including but not limited to a flat text file, a word processing document, a spreadsheet, a database, a web page, a business rule, a federation of information silos.

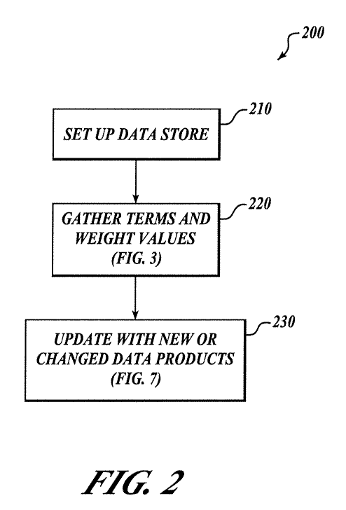

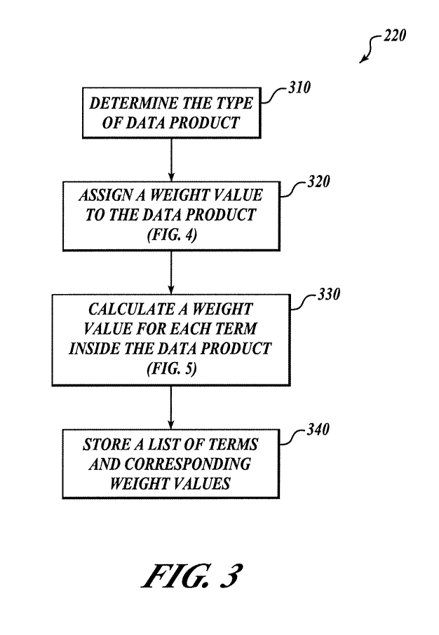

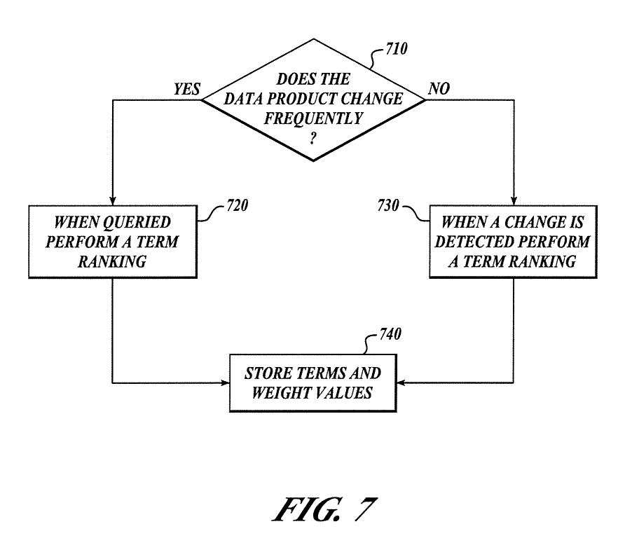

FIG. 2 shows a method 200 formed in accordance with an embodiment of the present invention. At block 210, a data store, in the form of a database, is setup. The database is setup with tables that allow for the storage of terms, their respective weight values, as well as relationships between tables, and the location of the data product where the term originated. At block 220, the method 200, using the hardware described in FIG. 1, gathers terms with their respective weight values from a data product, described in more detail below in FIG. 3. At block 230, the data product is updated; described in more detail in FIG. 7.

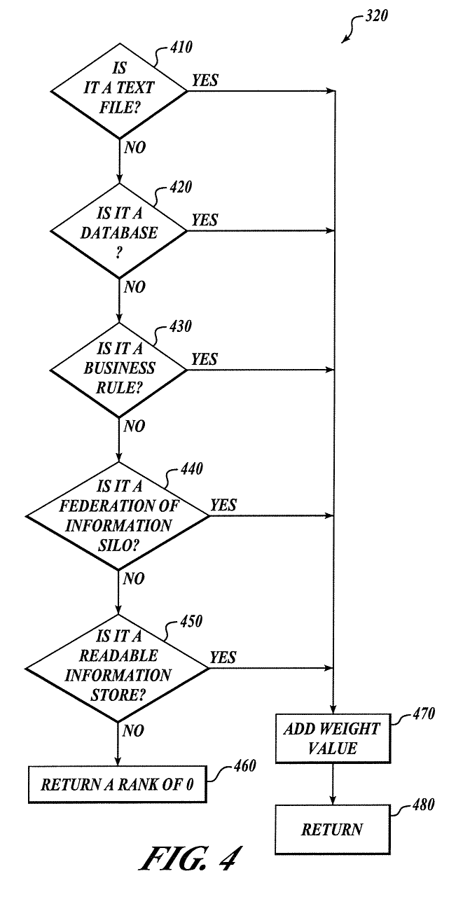

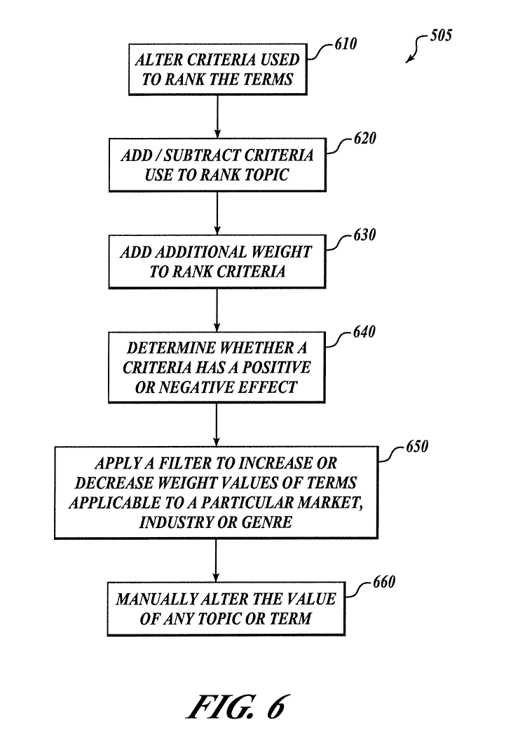

FIG. 3 further describes the process described at block 220 of FIG. 2. At block 310, the type of data product to be analyzed is determined by analyzing the properties of each data product. At block 320, a weight value is assigned to the document based on the file type and a predefined user criteria, farther described in FIG. 6. The method further determines a rank by considering characteristics of the data product as a whole, such as misspellings or grammatical errors contained therein, length and/or type of data product, and/or the uniqueness or organization of the text. This process is further defined in FIG. 4.

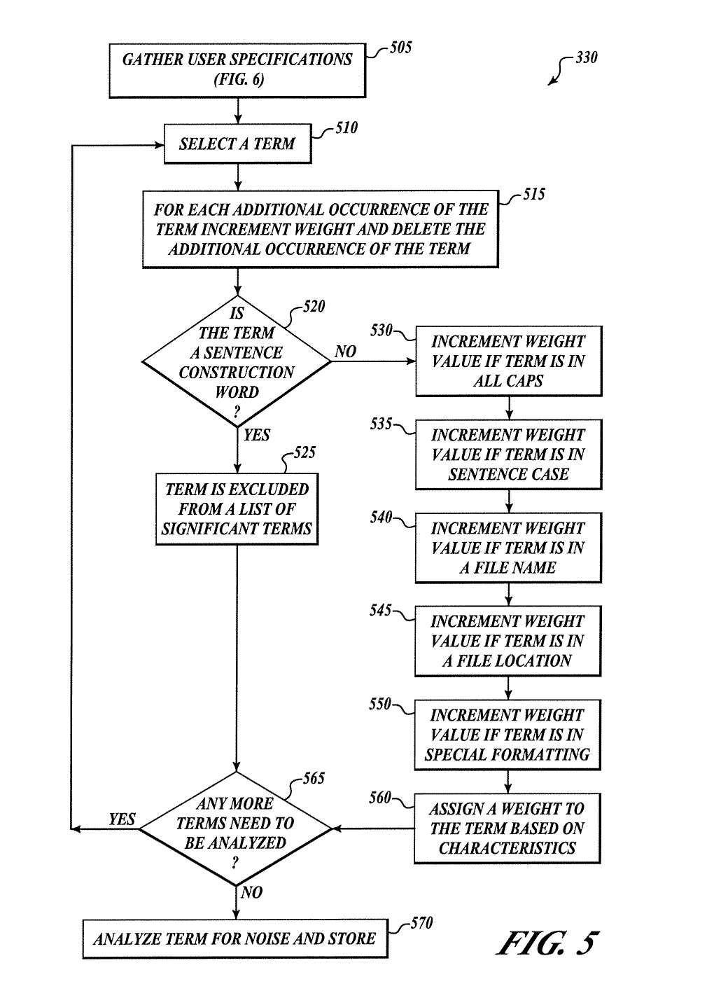

At block 330, a weight value for each term is calculated. The method parses a data product in order to retrieve terms from each data product in accordance with a first embodiment. After a data product type has been identified the method parses each term therein and a parsed list of terms for each data product is stored. Each term starts with its weight value equal to the weight value of the data products that it was found in. The method of determining a weight value of each term is further described below at FIG. 5. At block 340, the method stores the list of terms along with their respective weight values in the database.

FIG. 4 further describes the method described at block 310 of FIG. 3. At block 410, the method determines if the data product is a text file. If it is text file then the weight value of the terms is determined by a numerous set of criteria and methodologies in the form of an algorithm. The criteria and methodologies used are adjustable to rank/weight (hereinafter “rank”) higher, lower, require or exclude in order to refine and filter searches to find the desired information and/or exclude undesired information, documents or pages. These algorithms use characteristics of terms comprised of cues, attributes, formatting, criteria, features and interactions of terms, concepts and objects as their basis for the algorithmic function. There are additional characteristics that may be used in alternate embodiments that are not included on this list. In some cases, this basis is the existence or lack of existence of the characteristic, the frequency of the characteristic, the interaction of the characteristic, etc.

All, any combination or none of the characteristics below can be dynamically set to rank higher, lower, require, exclude or to not be used in the ranking. In an exemplary embodiment, the presence of any of the following adds a weight value e.g. one to the term. There are additional characteristics that may be used in alternate embodiments that are not included on this list.

Terms, concepts or objects are Bold: A variable ranking can be applied, such as bold ranks higher unless a % or more of the document is Bold, then Bold is not used for ranking or ranks lower;

Terms, concepts or objects are Caps (All, Small): A variable ranking can be applied, such as Caps ranks higher unless a % or more of the document is Caps, then Caps is not used for ranking or ranks lower; if a specific language that does not have case or uses pictographs, then Caps ranking is not used;

Terms, concepts or objects are Underlined: A variable ranking can be applied, such as Underlined ranks higher unless a % or more of the document is Underlined then Underlined is not used for ranking or ranks lower;

Terms, concepts or objects are Italicized: A variable ranking can be applied, such as Italics ranks higher unless a % or more of the document is Italics then Italics is not used for ranking or ranks lower;

Terms, concepts or objects are A Specific Color or Color Range;

Terms, concepts or objects are The Same Color as The Color of The Background;

The same color text as background is done to hide the text and is often found on Porn Sites and sites trying to drive traffic even though the “visible” content of their page often does not include the searched terms, concepts or objects;

Terms, concepts or objects are Within Quotation Marks or other Punctuation Marks;

Terms, concepts or objects are Within Parenthesis, Brackets or Braces;

Terms, concepts or objects have Combined Formatting: For example Bold, All Caps, Underlined and within Quotation Marks;

Terms, concepts or objects are a different Font or Font Size from the majority of the document;

Terms, concepts or objects have a Line Position attribute: Centered, Right, Left, Indented;

Terms, concepts or objects are Included in Header or Footer;

Terms, concepts or objects are Included in a Document or Section Title;

Terms, concepts or objects are in Column or Row Headings;

Terms, concepts or objects are in a Specified Column or Row;

Terms, concepts or objects have a Specified Value within a Field in a Database, Spreadsheet, Table, Form, etc.;

Terms, concepts or objects are In Captions or Legends;

Terms, concepts or objects are Included in the File Name;

Terms, concepts or objects are Included in the Name of “Containing” Folder, Directory, Drive or Network or Web Location;

Terms, concepts or objects ranking can be adjusted dynamically based on the other files in the same location;

Terms, concepts or objects are In Files within the “Open Recently” of word processor, spreadsheet, presentation applications, and of operating systems, etc.;

Terms, concepts or objects are In Files On Specific Classifications of Websites: Government, News, Medical, Technology, Education, etc.;

Terms, concepts or objects are In Files With Specific Domains: .com, net, .biz, .edu, .uk, .ir, etc.;

Terms, concepts or objects are Hyperlinked To Another Location: in the file, another file, another address, etc.;

Terms, concepts or objects are In a Specific Location Within the Document: near beginning, near end, etc.;

Terms, concepts or objects are In The Table of Contents;

Terms, concepts or objects are In The Index;

Terms, concepts or objects are Tagged with a Footnote or Endnote or Included in a Footnote or Endnote;

Terms, concepts or objects are In an Outline or Bulleted Format or List;

Terms, concepts or objects are In a Table;

Terms, concepts or objects have a Specific Style: Heading 1, Body Copy, Normal, Etc.;

Terms, concepts or objects are In a Text Box;

Terms, concepts or objects are In a Specific Field: In title field, header field, body field, etc.;

Terms, concepts or objects are In Redline, Track Changes or Comments;

Terms, concepts or objects are ranked based on Frequency in the File: A variable ranking can be applied, such as Frequency>n but<m is rank higher, Frequency>m rank lower, or Frequency>n rank higher unless Frequency is % or more of the file, then Frequency rank lower or exclude;

Terms, concepts or objects are Repeated Successively: A variable ranking can be applied, such as Successive Repetition 2, 3 or 4, rank higher; Successive Repetition>4 rank lower or exclude;

Terms, concepts or objects are ranked based on Frequency in All The Files Within The Search;

Terms, concepts or objects are Contained Within an External List, Table or Database:

Within drug database—Rank Higher;

Industry specific dictionary—Rank Higher;

Noise words—Rank Lower or Exclude;

The, and, an, or, because, if, etc.;

Spam Database—Rank Lower or Exclude; and

Parental Filter—Rank Lower or Exclude;

Terms, concepts or objects are Related to an Industry Specific Term contained within the file, for example:

Industry specific term is BP, 120/74 is Ranked Higher;

Industry specific term is ICD, the code number is Ranked Higher;

Industry specific term is Diagnosis, to be Ranked Higher is the following term, phrase, or list of terms or phrases; and

Industry specific term is plaintiff, the name of the plaintiff is Ranked Higher;

Terms, concepts or objects have Specific File Dates or Date Ranges: Creation, Update, Posted, Sent, Reply, etc.;

Terms, concepts or objects are Within the File Properties or Summary: Author, Machine, Dates, Category, etc.;

Terms, concepts or objects are Preceded by, Followed by, or Include Special or Unusual Characters, for example: @, %, &, !, #, $ etc;

Terms, concepts or objects are Within Markup Language Designated Sections;

Terms, concepts or objects are Within Specific and/or Industry Specific Sections Within the Files: Preface, Introduction, Complaint, Defendant, Claim, History of Present Illness, Allergies, Medications, etc.;

Terms, concepts or objects are In a Specific Language;

Terms, concepts or objects are ranked based on Frequency in “similar queries”;

Terms, concepts or objects are On or From a Specific Device Type of Origination or Current Location;

Terms, concepts or objects are Considered Vulgar: This ranking characteristic can be implemented to Rank Lower or Exclude “all” files, sites or pages that contain vulgar words;

Terms, concepts or objects that Have Keywords or Meta Tags that are Not Present in Visible Text: This ranking characteristic can be implemented to rank lower or exclude “all” files, sites or pages that do not have visible terms, concepts or objects that are listed in the Keywords or Meta Tags;

Terms, concepts or objects are Auto Linked, Auto Forwarded, or Drive Pop Ups.

If the data product is not a text file, at block 420 the data product is analyzed to determine if it is a database. Weight values are assigned to terms in a database, similar as discussed above for text files. The terms present within a particular database may also be afforded rank values based on their individual levels of significance, relative to other topics within the same or other databases. The weight value of terms within a database may be affected by, but not limited to, the presence of term within the database rows and/or columns; the use of a particular term within certain database objects. In one exemplary embodiment a term may be considered more significant if it appears in an e.g. “trouble ticket” table as opposed to an e.g. “location” table. The presence of embedded documents with the database or use of the topic with the embedded document and the applicability and/or usefulness of a particular topic to differing users or departments of an organization affects the weight value.

If the data product is not a database, at block 430 the data product is analyzed to determine if it is a business rule. A business rule contains documentation that describes how a business generally operates. It may contain user specifications for determining weight value of terms, formatting guidelines, company best practices, naming conventions, etc. These terms are given a high value as they may have a great effect on how a business operates and how it identifies significant terms.

If the data product is not a business rule, at block 440 the data product is analyzed to determine if it is a federation of information silos. A federation of information silos allows for the aggregation of information across separate data products. This may offer the ability to rank topics based simply on their existence or nonexistence within the same or other related or unrelated stores, or the topic's existence or nonexistence within a particular store may positively or negatively affect its rank value. For example, a topic may be increased in rank if it is found in a user's desk reference information store and a topically related digital library information store.

If the data product is not a federation of information silos, at block 450 the data product is analyzed to determine if the data product is a readable data product. If so, then it is assigned an initial weight value of zero, in one embodiment, and the terms are analyzed based on block 410. If it is not a readable data product, then the weight is returned as null and it is a data product that will not appear in the results.

If in block 410, 420, 430, 440, or 450 the data product is determined a readable data product, then the terms are assigned a weight value at block 470. The method then returns after updating the database at block 480.

FIG. 5 shows an exemplary embodiment of the method described at block 330 of FIG. 3. At block 505 a user is to enter their specifications and is further described below in FIG. 6. At block 510, a term is selected from the generated parsed list of terms. At block 515, for each occurrence of the term, a weight value is incremented and the additional occurrence of the term is deleted from the list. A term's weight value is defined as a number assigned to a word, such that in a computation the word's effect on the computation reflects its importance. At decision block 520, the term is tested to determine whether the word is a sentence construction word. If the term is a sentence construction word then the term is removed and excluded from the parsed list see block 525.

Sentence construction words are those used commonly in written text to build sentences, but have very little content information. They include words such as “and”, “the”, “this”, “of”. Because they are common, the algorithm for determining significance of a term might incorrectly assign a high significance to these words that carry very little meaning. A configurable list of sentence construction words is maintained and no term is added to the term storage or weighted for a data product that is found in this list. Any query terms which match a sentence construction word are ignored, and if all the terms in a query are sentence construction words, the query is rejected.

In an exemplary embodiment, a term's weight value is incremented if the term is in all caps see block 530. A term's weight value is incremented if the term is in sentence case see block 535. Sentence case is defined as a term that is all lower case, or is just capitalized because the term follows a period, i.e. is the start of a new sentence. A term's weight value is incremented if the term is in the name of the data product containing the term see block 540. A term's weight value is incremented if the term is in the file location of the data product see block 545. A term's weight value is incremented if the term has any special formatting (see block 550). For example, special formatting includes italics, underline, and larger font than most of the other text in the data product, quotations marks and/or strikethrough. Additional factors can be used to generate or adjust weights of terms, depending upon the data product format and application needs. In one embodiment, a term's weight value is incremented based on a terms proximity to a query term found in the data product (See FIG. 6). In another embodiment, a term's weight value is increased or decreased if the term is found within specified sections of the data product. One embodiment would adjust the term's weight based on a dictionary of terms suitable to the data product and application system. After a term has been analyzed the final weight is then assigned to the term 560. At decision block 565 the parsed list is checked to determine if there are any additional terms to be analyzed. If so, the method returns to block 550 to enable the next term to be analyzed. If there are not any additional terms to be analyzed, then the weighted parsed list is returned to block 330 in FIG. 3.

At block 570, terms are determined to be insignificant by ranking all of the terms in a data product and then finding the value where terms begin a sequence (of configurable length) with the same value. It can be assumed that a sequence of terms with the same value reflects terms that are not particularly descriptive of the contents of the data product. All terms with weight values above the weight value of the terms with the first repeated value will be flagged as significant terms, so long as they are not sentence construction words.

FIG. 6 shows one embodiment of entering user specifications as shown at block 505 in FIG. 5. At block 610, a user is given the capability to alter criteria used to determine weight value. At block 620, a user is given the capability to add/subtract or mitigate the effects of any, some or specific ranking criteria or methodologies may afford another opportunity to meld the user's ideas of exactly what should be considered significant with the machine-calculable significance. At block 630, a user may add additional weight to at block 640; a user may decide whether a criterion or methodology has a positive or negative effect on the ranking of the topic(s). Further, at block 660, the user may apply a customizable filter(s) to automatically increase or decrease the ranks of topics applicable to a particular market, industry or genre. In one exemplary embodiment, one topic may have a different meaning or connotation to the government or military than it does in the healthcare field. If the user is searching for the topic within the military genre, the user may manually or the filter may automatically increase the rank of topics found on a .MIL or .GOV domain. At block 660, the user may also be given the capacity to manually alter the weight value of any topic within an information store. In this instance, the user may remove the topic from consideration, add a topic which does not qualify for consideration or modify the weight value of a topic in some other fashion.

FIG. 7 shows one embodiment of scanning data products and storing weight values. At block 710, it is determined whether the content in the data product changes frequently. If it does then at block 720, determining a weight value may be performed as a result of a user query. If the data product is not frequently changing then at block 730, when a change is detected by an indexing system the method will determine the weight values of the terms at that time. At block 740 the results are stored.

In an alternate embodiment, the method and system ranks topics extracted from a data product using a semantic search engine. Such a search engine attempts to derive the syntactical, grammatical and/or semantic meanings found within a user's search query, for example, by using a combination of punctuation scrutiny, statistical, probabilistic and cognitive analyses, chronological analysis and text styling analysis to garner machine understanding of human language.

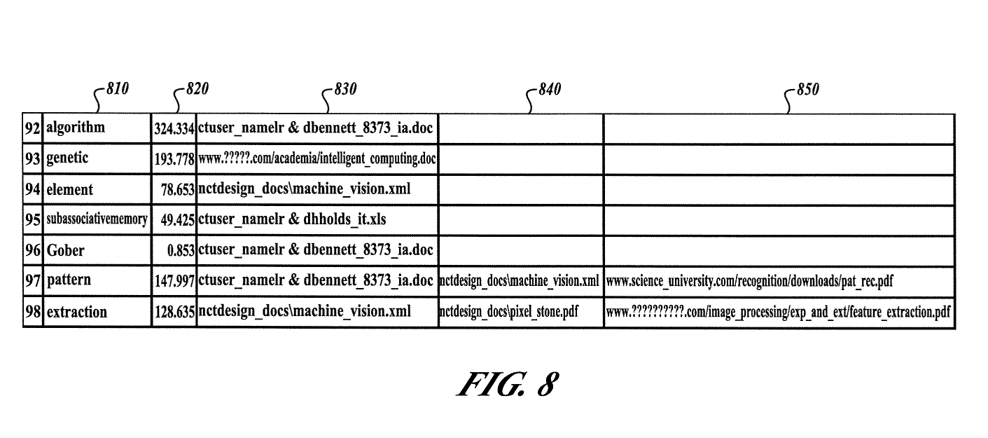

FIG. 8 shows an example table that stores terms, weight values, and the data product location. At block 810 the term is stored. At block 820, the term's weighted value is stored. At blocks 830, 840, and 850 the term's location is stored.

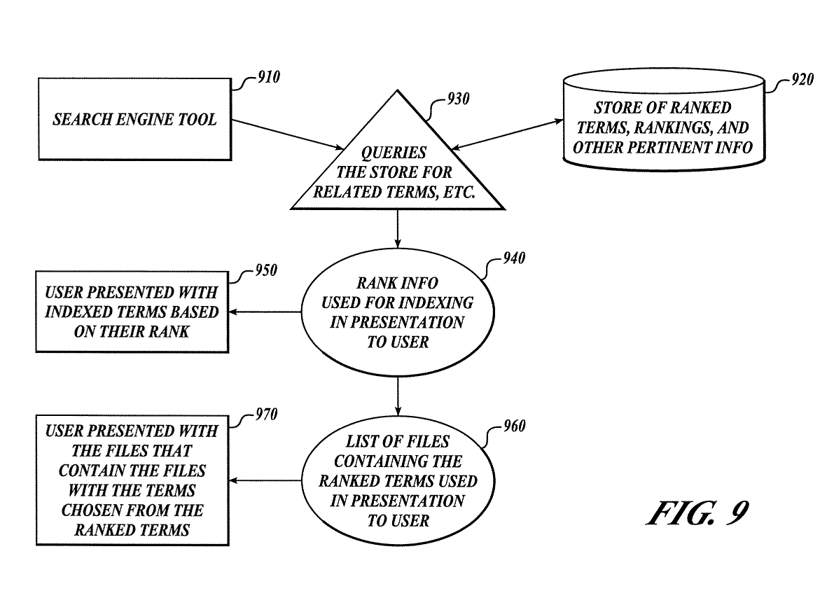

FIG. 9 shows an example of how a list of weighted terms is used. At block 910 a search tool, using a search string sends a search query. At block 930 the data store 920 is queried for related terms. At block 940 the weight values are received and indexed for display to a user. At block 950, the user is presented with indexed terms based on their rank. At block 960, a user is presented with a list of files containing the ranked terms in presentation to the user. At block 970, the user is presented with the files with the terms chosen from the ranked terms.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for determining the significance of a term in a plurality of data products stored at one or more locations over a computer-based network, the method comprising:
determining the type of the data product;
assigning a weight value to the data product based on a list of predetermined variables;
calculating, using a processor, a weight value for each term inside the data product, the weight value comprising the weight value assigned to the data product added to the weight value of the term calculated based on a list of predetermined variables;
storing a list of terms based on the calculated weight value for each term; and
querying the stored list of terms with a search query and displaying a set of significant terms to a user.

2. The method of claim 1, further comprising:
parsing the data product to extract the terms and storing the terms on a digital medium.

3. The method of claim 1, further comprising:
prompting a user to enter additional criteria to effect the calculation of the weight value.

4. The method of claim 3, wherein prompting a user includes deleting predetermined variables.

5. The method of claim 4, wherein additional criteria includes determining whether the predetermined variable increases or decreases the weight value of a term.

6. The method of claim 4, wherein additional criteria includes manually altering the weight value of a term.

7. A method for determining significant terms in a data product containing text, the method comprising:
assigning a weight value to the data product based on a list of predetermined variables;
calculating, using a processor, a weight value for each term inside the data product, the weight value comprising the weight value assigned to the data product added to the weight value of the term calculated based on a list of predetermined variables;
storing a list of terms based on the calculated weight value for each term; and
querying the stored list of terms with a search query and displaying a set of significant terms to a user.

8. The method of claim 7, further comprising:
adjusting the weight value of a data product based on its location.

9. The method of claim 8, further comprising:
using a processor to scan a data product for spelling and adjusting the weight value of the data product based on the results.

10. The method of claim 9, further comprising:
parsing the data product to extract the terms and storing the terms on a digital medium.

11. The method of claim 10, wherein the weight value of a term is incremented based on formatting characteristics.

12. The method of claim 11, wherein the weight value of a term is incremented based on frequency.

13. The method of claim 12, wherein the weight value of a term is incremented based on its surrounding terms.

14. The method of claim 12, further comprising:
prompting a user to enter additional criteria to effect the calculation of the weight value.

15. A system for searching a plurality of data products, the system comprising:
a database configured to store significant term information for the plurality of data products;
a display; and
a processor in data communication with the display and with the database, the processor comprising:
a first component configured to assign a weight value to the data product based on a list of predetermined variables;
a second component configured to calculate, using a processor, a weight value for each term inside the data product, the weight value comprising the weight value assigned to the data product added to the weight value of the term calculated based on a list of predetermined variables; and
a third component configured to store a list of terms based on the calculated weight value for each term;
a fourth component configured to query the stored list of terms with a search query and display a set of significant terms to a user;
wherein the components are located on at least one of a stand alone computer or a plurality of computers coupled to a network.

16. The system of claim 15, further comprising:
a fifth component to parse the data product to extract the terms and storing the terms on a digital medium.

17. The system of claim 15, further comprising:
a sixth component to prompt a user to enter additional criteria to effect the calculation of the weight value.

18. The system of claim 17, wherein the prompt of a user includes deleting predetermined variables.

19. The system of claim 18, wherein additional criteria includes determining whether the predetermined variable increases or decreases the weight value of a term.

20. The system of claim 19, wherein additional criteria includes manually altering the weight value of a term.
